(19) United States
(12) Patent Application Publication
(10) Pub. No.: US 2014/0341200 A1
(43) Pub. Date: Nov. 20, 2014

(54) APPARATUS, SYSTEM, AND METHOD FOR REDUCING SIGNAL INTERFERENCE IN A HIGHLY DENSE WIRELESS ENVIRONMENT

(71) Applicant: Robert B. Vukich, South Jordan, UT (US)

(72) Inventor: Robert B. Vukich, South Jordan, UT (US)

(21) Appl. No.: 14/283,065

(22) Filed: May 20, 2014

Related U.S. Application Data
(60) Provisional application No. 61/825,324, filed on May 20, 2013.

(51) Int. Cl. H04W 28/04; H04W 48/16

(52) U.S. Cl. CPC H04W 28/048; H04W 48/16
USPC 370/338

(57) ABSTRACT

An apparatus for reducing signal interference in a highly dense wireless environment has a listener module, a response module, and a tracking module. The listener module receives, at a network access point affiliated with a collection of network SSIDs, an association request from a mobile device, the association request having a foreign network SSID. The response module sends an association response to the mobile device accepting the association request in response to receiving the association request, the response having a connection identifier. The tracking module updates the collection of one or more network SSIDs affiliated with the network access point with the foreign network SSID.

### FIELD

The subject matter disclosed herein relates to reducing signal interference and more particularly relates to reducing signal interference in an environment with a high density of wireless mobile devices.

### BACKGROUND

Wireless mobile devices are ubiquitous in society today. The percentage of individuals who carry a smartphone, tablet computer, and/or laptop computer with them throughout the day continues to increase. These wireless mobile devices have the ability to connect wirelessly to wireless networks (e.g., wi-fi networks) and continuously probe for such networks to join. This probing for wireless networks occurs regardless of whether the user is actively using the mobile device or needs to utilize a wireless network. Each mobile device, when probing for a wireless network to join, generates a steady stream wireless signals. In a densely populated area, such as a large entertainment venue (e.g., sports arena, concert hall), the high density of wireless mobile devices and the accompanying wireless signals dramatically increases signal interference that disrupts wireless connectivity.

### SUMMARY

An apparatus for reducing signal interference in a highly dense wireless environment includes a listener module, a response module, and a tracking module. The listener module receives, at a network access point affiliated with a collection of one or more network service set identifiers (SSIDs), an association request from a mobile device, the association request having a foreign network SSID. The response module sends an association response to the mobile device accepting the association request in response to receiving the association request, the response having a connection identifier. The tracking module updates the collection of one or more network SSIDs affiliated with the network access point with the foreign network SSID.

In one embodiment, the tracking module updates the collection of one or more network SSIDs affiliated with the network access point with the foreign network SSID by associating the foreign network SSID with an identifier of the network access point.

In another embodiment, the tracking module also updates the collection of one or more network SSIDs affiliated with the network access point with a collection of foreign network SSIDs affiliated with one or more other network access points.

In yet another embodiment, the tracking module also tracks a number of mobile devices connected to the network access point using a network SSID affiliated with the network access point.

In still another embodiment, the apparatus also includes a notification module that transmits the collection of one or more network SSIDs affiliated with the network access point to one or more other network access points.

In an embodiment, the notification module also broadcasts a network profile to the mobile device, the network profile having a network SSID pertaining to the collection of one or more network SSIDs affiliated with the network access point.

A method for reducing signal interference in a highly dense wireless environment includes (i) receiving, at a network access point affiliated with a collection of one or more network service set identifiers (SSIDs), an association request from a mobile device, the association request having a foreign network SSID; (ii) sending an association response to the mobile device accepting the association request in response to receiving the association request, the response having a connection identifier; and (iii) updating the collection of one or more network SSIDs affiliated with the network access point with the foreign network SSID.

In one embodiment, the method also includes updating the collection of one or more network SSIDs affiliated with the network access point with the foreign network SSID by associating the foreign network SSID with an identifier of the network access point.

In another embodiment, the method also includes updating the collection of one or more network SSIDs affiliated with the network access point with a collection of foreign network SSIDs affiliated with one or more other network access points.

In yet another embodiment, the method also includes tracking a number of mobile devices connected to the network access point using a network SSID affiliated with the network access point.

In still another embodiment, the method also includes transmitting the collection of one or more network SSIDs affiliated with the network access point to one or more other network access points.

In an embodiment, the method also includes broadcasting a network profile to the mobile device, the network profile having a network SSID pertaining to the collection of one or more network SSIDs affiliated with the network access point.

A computer program product for reducing signal interference in a highly dense wireless environment includes computer readable storage medium storing computer usable program code executable to (i) receiving, at a network access point affiliated with a collection of one or more network service set identifiers (SSIDs), an association request from a mobile device, the association request having a foreign network SSID; (ii) sending an association response to the mobile device accepting the association request in response to receiving the association request, the response having a connection identifier; and (iii) updating the collection of one or more network SSIDs affiliated with the network access point with the foreign network SSID.

In one embodiment, the computer program product also includes code executable to updating the collection of one or more network SSIDs affiliated with the network access point with the foreign network SSID by associating the foreign network SSID with an identifier of the network access point.

In another embodiment, the computer program product also includes code executable to updating the collection of one or more network SSIDs affiliated with the network access point with a collection of foreign network SSIDs affiliated with one or more other network access points.

In yet another embodiment, the computer program product also includes code executable to tracking a number of mobile devices connected to the network access point using a network SSID affiliated with the network access point.

In still another embodiment, the computer program product also includes code executable to transmitting the collection of one or more network SSIDs affiliated with the network access point to one or more other network access points.

In an embodiment, the computer program product also includes code executable to broadcasting a network profile to the mobile device, the network profile having a network SSID pertaining to the collection of one or more network SSIDs affiliated with the network access point.

### BRIEF DESCRIPTION OF THE DRAWINGS

In order that the advantages of the embodiments of the invention will be readily understood, a more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a system for reducing signal interference in a highly dense wireless environment;

FIG. 2 is a schematic block diagram illustrating one embodiment of an apparatus for reducing signal interference in a highly dense wireless environment;

FIG. 3 is a schematic block diagram illustrating another embodiment of an apparatus for reducing signal interference in a highly dense wireless environment;

FIG. 4 is a schematic flow chart diagram illustrating one embodiment of a method for reducing signal interference in a highly dense wireless environment;

FIG. 5 is a schematic flow chart diagram illustrating another embodiment of a method for reducing signal interference in a highly dense wireless environment;

FIG. 6 is a schematic flow chart diagram illustrating yet another embodiment of a method for reducing signal interference in a highly dense wireless environment;

FIG. 7 is a schematic flow chart diagram illustrating still another embodiment of a method for reducing signal interference in a highly dense wireless environment; and

FIG. 8 is a schematic flow chart diagram illustrating a further embodiment of a method for reducing signal interference in a highly dense wireless environment.

### DETAILED DESCRIPTION

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments.

These features and advantages of the embodiments will become more fully apparent from the following description and appended claims, or may be learned by the practice of embodiments as set forth hereinafter. As will be appreciated by one skilled in the art, aspects of the present invention may be embodied as a system, method, and/or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer readable medium(s) having program code embodied thereon.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of program code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of program code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the program code may be stored and/or propagated on in one or more computer readable medium(s).

The computer readable medium may be a tangible computer readable storage medium storing the program code. The computer readable storage medium may be, for example, but not limited to, an electronic, magnetic, optical, electromagnetic, infrared, holographic, micromechanical, or semiconductor system, apparatus, or device, or any suitable combination of the foregoing.

More specific examples of the computer readable storage medium may include but are not limited to a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), an optical storage device, a magnetic storage device, a holographic storage medium, a micromechanical storage device, or any suitable combination of the foregoing. In the context of this document, a computer readable storage medium may be any tangible medium that can contain, and/or store program code for use by and/or in connection with an instruction execution system, apparatus, or device.

The computer readable medium may also be a computer readable signal medium. A computer readable signal medium may include a propagated data signal with program code embodied therein, for example, in baseband or as part of a carrier wave. Such a propagated signal may take any of a variety of forms, including, but not limited to, electrical, electro-magnetic, magnetic, optical, or any suitable combination thereof. A computer readable signal medium may be any computer readable medium that is not a computer readable storage medium and that can communicate, propagate, or transport program code for use by or in connection with an instruction execution system, apparatus, or device. Program code embodied on a computer readable signal medium may be transmitted using any appropriate medium, including but not limited to wire-line, optical fiber, Radio Frequency (RF), or the like, or any suitable combination of the foregoing

In one embodiment, the computer readable medium may comprise a combination of one or more computer readable storage mediums and one or more computer readable signal mediums. For example, program code may be both propagated as an electro-magnetic signal through a fiber optic cable for execution by a processor and stored on RAM storage device for execution by the processor.

Program code for carrying out operations for aspects of the present invention may be written in any combination of one or more programming languages, including an object oriented programming language such as Java, Smalltalk, C++, PHP or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The computer program product may be shared, simultaneously serving multiple customers in a flexible, automated fashion. The computer program product may be standardized, requiring little customization and scalable, providing capacity on demand in a pay-as-you-go model. The computer program product may be stored on a shared file system accessible from one or more servers.

The computer program product may be integrated into a client, server and network environment by providing for the computer program product to coexist with applications, operating systems and network operating systems software and then installing the computer program product on the clients and servers in the environment where the computer program product will function.

In one embodiment software is identified on the clients and servers including the network operating system where the computer program product will be deployed that are required by the computer program product or that work in conjunction with the computer program product. This includes the network operating system that is software that enhances a basic operating system by adding networking features.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and computer program products according to embodiments of the invention. It will be understood that each block of the schematic flowchart diagrams and/or schematic block diagrams, and combinations of blocks in the schematic flowchart diagrams and/or schematic block diagrams, can be implemented by program code. The program code may be provided to a processor of a general purpose computer, special purpose computer, sequencer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The program code may also be stored in a computer readable medium that can direct a computer, other programmable data processing apparatus, or other devices to function in a particular manner, such that the instructions stored in the computer readable medium produce an article of manufacture including instructions which implement the function/act specified in the schematic flowchart diagrams and/or schematic block diagrams block or blocks.

The program code may also be loaded onto a computer, other programmable data processing apparatus, or other devices to cause a series of operational steps to be performed on the computer, other programmable apparatus or other devices to produce a computer implemented process such that the program code which executed on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and computer program products according to various embodiments of the present invention. In this regard, each block in the schematic flowchart diagrams and/or schematic block diagrams may represent a module, segment, or portion of code, which comprises one or more executable instructions of the program code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and program code.

The description of elements in each figure may refer to elements of proceeding figures. Like numbers refer to like elements in all figures, including alternate embodiments of like elements.

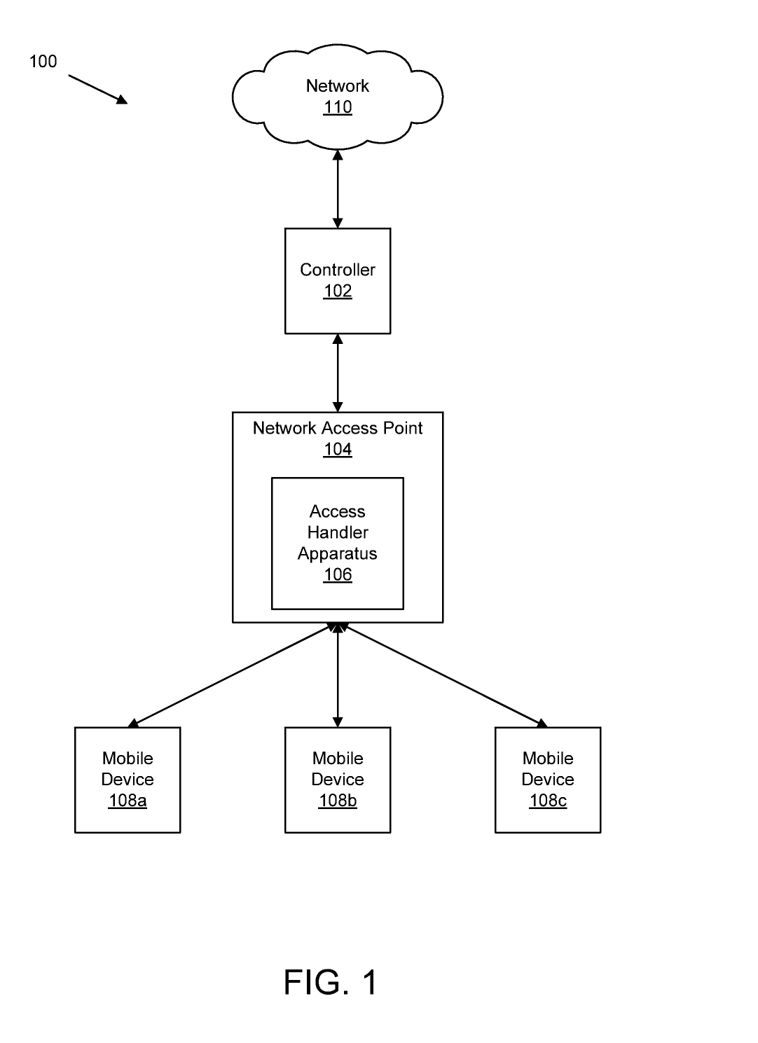

FIG. 1 is a schematic block diagram illustrating one embodiment of a system for reducing signal interference in a highly dense wireless environment. The system 100 includes multiple mobile devices 108a-c (collectively, 108) wirelessly connected to a network 110 through a network access point 104, an access handler apparatus 106, and a controller 102, which are described further below.

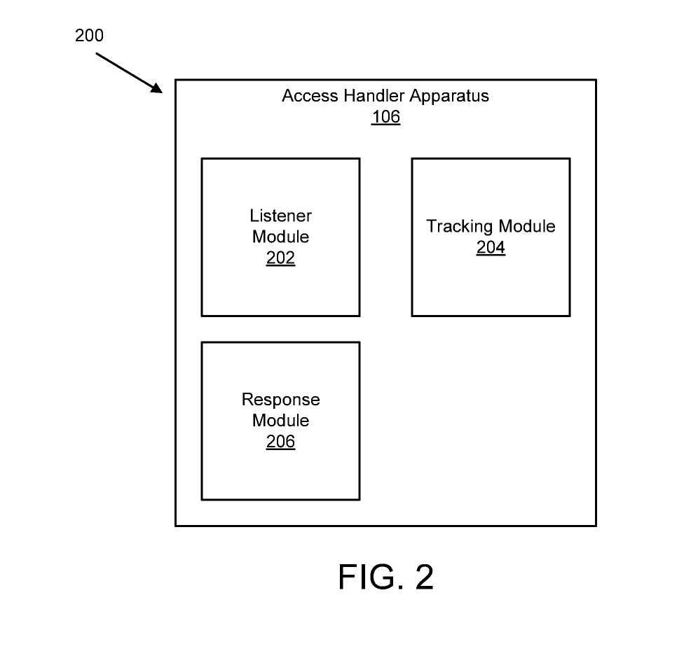

In one embodiment, the system includes mobile devices 108 in wireless communication with a network access point 104 having an access handler apparatus 106 to access a network 110. The access handler apparatus 106 is described in more detail with respect to the apparatus 200 in FIG. 2. The mobile device 108 may be any device capable of establishing a wireless network connection. For example, the mobile device 108 may be a laptop or desktop computer. In another example, the mobile device 108 may be a tablet (e.g., iPad, Kindle Fire, Nook). In further example, the mobile device 108 may be a smartphone (e.g., iPhone, Blackberry, Android phone). The network 110 may include a local area network (“LAN”), a wide area network (“WAN”), wireless network, cellular network, the internet, or the like.

In one embodiment, the access handler apparatus 106 resides on both a network access point 104 and the controller 102. In this instance, a portion of the access handler apparatus 106 resides on the controller 102 and another portion of the access handler apparatus 106 resides on a network access point 104. In a certain embodiment, the network access point 104 may be a wireless access point. In an alternative embodiment, the network access point 104 may be a wireless router. One of skill in the art will recognize other forms of a network access point.

The controller 102 manages the routing of data packets between the network 110 and mobile devices 108 through one or more network access points 104. In one embodiment, the controller 102 keeps track of whether a network address (e.g., IP address) is available for use and assigns network addresses for use by mobile devices 108. In another embodiment, the controller keeps track of the connections between network access points 104 and mobile devices 108. This allows the controller 102 to route data packets destined for a mobile device 108 through the proper network access point 104 (i.e., the network access point 104 currently in communication with the mobile device 108). For instance, a user with a mobile device 108 in communication with a first network access point 104 may move out of range of the first network access point 104 and into the range of a second network access point 104. In this instance, the mobile device 108 may associate with the second network access point 104, and the controller 102 tracks this connection so that it will route data packets for the mobile device 108 to the second network access point 104 instead of the first network access point 104. In one embodiment, the controller 102 tracks the connection between a mobile device 108 and a network access point 104 by tracking the IP address assigned to a mobile device 108, or the media access control (MAC) address of the mobile device 108, and the access point identifier of the network access point 104 in communication with the mobile device 108. In another embodiment, the controller 102 tracks a collection of network Service Set Identifiers (SSIDs) affiliated with one or more network access points 104. The controller 102 may keep track of the aforementioned connections and affiliations in a variety of ways. For example, the controller 102 may store the connections and affiliations in one or more database tables and update these relationships when it is notified of a change in connection or affiliation. Alternatively, the controller 102 may store the connections and affiliations in a flat file and update the file. One of skill in the art will recognize other means of tracking the aforementioned relationships.

The network access point 104 forwards data packets between the network 110 and one or more mobile devices 108. A network access point 104 has a unique access point identifier. In one embodiment, a network access point 104 may associate with a plurality of mobile devices 108, and the network access point 104 may keep track of the mobile devices 108 by creating a connection identifier for each associated mobile device 108. In another embodiment, a network access point 104 may be affiliated with a collection of one or more network SSIDs, and the number of affiliated network SSIDs in the collection of network SSIDs may increase or decrease. In a certain embodiment, a network access point 104 queries the controller 102 to determine whether the network access point 104 is affiliated with a particular network SSID. Alternatively, a network access point 104 may keep track of the network SSIDs it is affiliated with. In one embodiment, a network access point 104 broadcasts the collection of network SSIDs it is affiliated with.

FIG. 2 is a schematic block diagram illustrating one embodiment of an apparatus for reducing signal interference in a highly dense wireless environment. The apparatus 200 includes a listener module 202, a tracking module 204, and a response module 206, which are described below.

Mobile devices 108 actively searching for networks to connect to will continuously send out association requests containing network SSIDs or probe requests seeking to determine networks within range. The steady stream of association and probe requests can often generate signal interference in dense wireless environments with lots of wireless devices. The listener module 202 receives association requests from one or more mobile devices 108 at a network access point 104. The association request comprises at least one of a network SSID for a network profile stored on the mobile device 108 or the MAC address of the mobile device 108. In one instance, the network SSID of the association request may match a network SSID affiliated with the network access point 104. In another instance, the network SSID of the association request may not match a network SSID affiliated with the network access point 104 (i.e., unrecognized by and foreign to the network access point 104).

Typically, a network access point is only affiliated with one network SSID and thus will reject association requests having a foreign network SSID. The response module 206 sends an association response to a mobile device 108 accepting an association request having a network SSID matching a network SSID in the collection of one or more network SSIDs affiliated with the network access point 104. But the response module 206 also sends an association response to a mobile device 108 accepting the association request having a foreign network SSID from the mobile device 108 in response to receiving the association request at the network access point 104. In one instance, the association response comprises a connection identifier that uniquely identifies the connection between a network access point 104 and a mobile device 108. In another instance, the association response comprises an IP address assigned to the mobile device 108.

Since the response module 206 accepts association requests having a foreign network SSID and sends an association response to the mobile device 108, the mobile device 108 is led to believe that it is connecting to a familiar network from one of its stored network profiles. Once the mobile device 108 establishes a connection with the network access point 104, it stops sending association and probe requests, thus reducing signal interference. By reducing signal interference from passive users' mobile devices, active mobile device users can have better connectivity and data throughput rates even in dense wireless environments.

The tracking module 204 tracks, in one embodiment, the number of mobile devices 108 currently connected to the network access point 104. In another embodiment, the tracking module 204 tracks the number of mobile devices 108 connected to the network access point 104 using a particular network SSID. For example, the tracking module 204 can track the number of mobile devices 108 currently connected to a network access point 104 using the network SSIDs “Netgear” and “Linksys,” where “Netgear” and “Linksys” are network SSIDs affiliated with the network access point 104. In a certain embodiment, the tracking module 204 tracks the number of mobile devices 108 connected to the network access point 104 using a particular network SSID during a specific period of time. For example, the tracking module 204 may track the number of mobile devices 108 connected to the network access point 104 using the network SSID “Netgear” during the past 15 minutes (i.e., 15 minute moving window) or from 7-8 pm on Fridays.

In one embodiment, the tracking module 204 also tracks the availability of a collection of network addresses (e.g., IP addresses). A network address may be assigned to a client device or unassigned. In an embodiment, the tracking module 204 assigns a network address to a client and marks the network address as unavailable. When notified that a client has disconnected from the network, the tracking module 204 marks network address assigned to that client as available. In one embodiment, the tracking module 204 tracks, for each network access point 104, the one or more mobile devices 108 associated with the network access point 104. In one instance, the connection between a mobile device 108 and a network access point 104 is represented by the access point identifier of the network access point 104 and the IP address assigned to the mobile device 108. In another instance, the connection between a mobile device 108 and a network access point 104 is represented by the access point identifier of the network access point 104 and the MAC address of the mobile device 108. In another embodiment, the tracking module 204 updates the collection of mobile devices 108 associated with a network access point 104 by adding to or removing from a database (or other storage format) the (i) IP address assigned to a mobile device 108 or (ii) MAC address of the mobile device 108.

The tracking module 204 also tracks, for each network access point 104, a collection of one or more network SSIDs affiliated with the network access point 104. The tracking module 204 also updates the collection of one or more network SSIDs affiliated with a network access point 104 with a foreign network SSID. The collection of one or more network SSIDs affiliated with a network access point 104 may be stored in a database or some other storage format. In one instance, the tracking module 204 updates the collection of one or more network SSIDs affiliated with a network access point 104 with a foreign network SSID by associating the foreign network SSID with an identifier of the network access point 104 in a database.

The tracking module 204 can also update the collection or one or more network SSIDs affiliated with a network access point 104 with a collection of one or more foreign network SSIDs affiliated with one or more other network access points 104. In one embodiment, the tracking module 204 updates the collection of one or more network SSIDs affiliated with a network access point 104 with a collection of foreign network SSIDs by associating each network SSID of the collection of foreign network SSIDs with an identifier of the network access point 104 in a database.

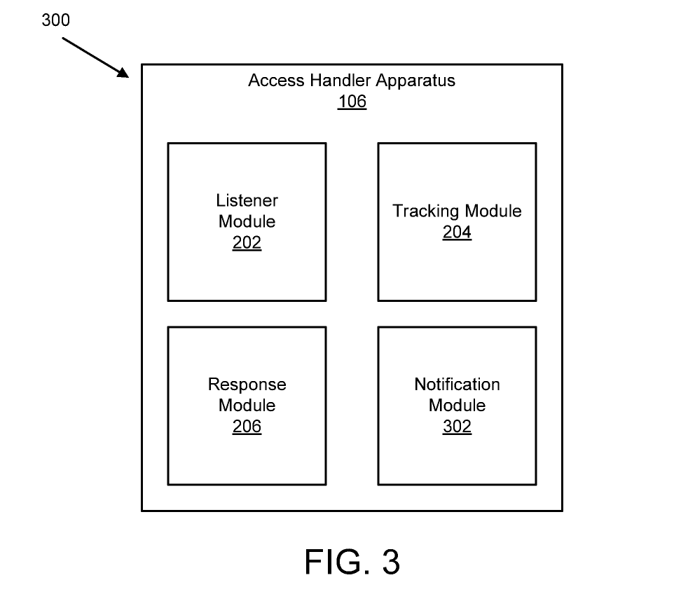

FIG. 3 is a schematic block diagram illustrating another embodiment of an apparatus for reducing signal interference in a highly dense wireless environment. The apparatus 300 includes a listener module 202, a tracking module 204, a response module 206, and a notification module 302. The listener module 202, tracking module 204, and response module 206 have been described above. The notification module 302 is described below.

The notification module 302 transmits the collection of one or more network SSIDs affiliated with a network access point 104 to one or more other network access points 104. In one embodiment, the notification module 302 transmits the collection of one or more network SSIDs affiliated with a network access point 104 to one or more other network access points 104 by transmitting the collection of network SSIDs to the controller 102. In this embodiment, the controller 102, which maintains a list of network access points 104, would then transmit the collection of network SSIDs to one or more other network access points 104. In another embodiment, the notification module 302 resides on the controller 102 and transmits the collection of network SSIDs to one or more other network access points 104.

The notification module 302 also broadcasts one or more network profiles to mobile devices 108, where a network profile has a network SSID from the collection of network SSIDs affiliated with a network access point 104. In one embodiment, the notification module 302 broadcasts in a cycle each network SSID in the collection of network SSIDs affiliated with a network access point 104. In another embodiment, the notification module 302 broadcasts one or more network profiles containing network SSIDs affiliated with the network access point 104 used by the most number of mobile devices 108 connected to the network access point 104. For example, if there are seven network SSIDs affiliated with a network access point 104 and 55 mobile devices 108 connected to the network access point 104, and 45 out of the 55 mobile devices are connected to the network access point 104 using three out of the seven network SSIDs, then the notification module 302 may only broadcast network profiles containing those three network SSIDs affiliated with the network access point 104. In this example, there is a higher probability that other mobile devices 108 are using these three network SSIDs. In another embodiment, the notification module 302 broadcasts one or more network profiles containing network SSIDs affiliated with the network access point 104 used by the most number of mobile devices 108 to connect to the network access point 104 during a certain period of time. For example, the notification module 302 can broadcast network profiles containing the two most commonly used network SSIDs used by mobile devices 108 to connect to the network access point 104 over the past 15 minutes (i.e., 15 minute moving window). In another example, the notification module 302 can broadcast network profiles containing the two most commonly used network SSIDs used by mobile devices 108 to connect to the network access point 104 between during a similar time period the day, week, or month before.

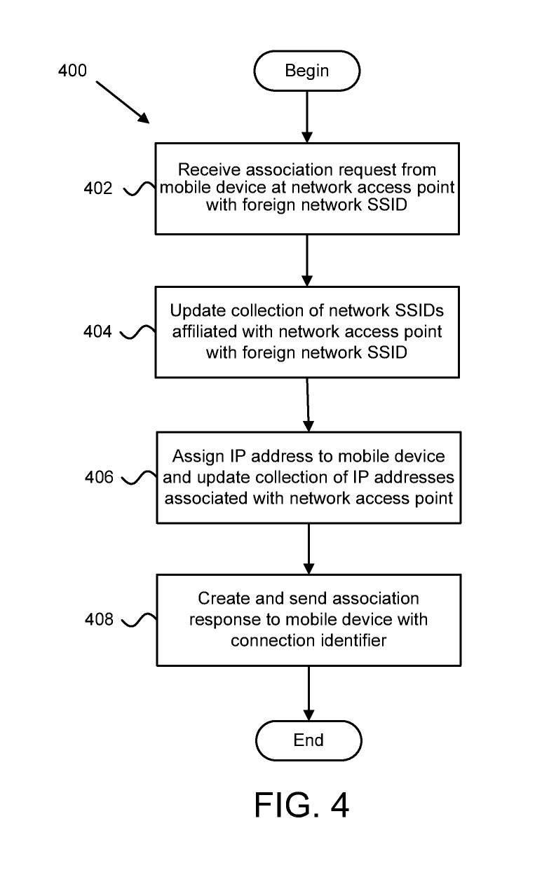

FIG. 4 is a schematic flow chart diagram illustrating one embodiment of a method for reducing signal interference in a highly dense wireless environment. The method 400 begins and receives 402, at a network access point 104 affiliated with a collection of network SSIDs, an association request from a mobile device 108 comprising an foreign network SSID of a network profile stored on the mobile device 108. In one embodiment, the method 400 updates 404 the collection of network SSIDs affiliated with the network access point 104 with the foreign network SSID by associating the foreign network SSID with an identifier of the network access point 104. The method 400 assigns 406 an IP address to the mobile device and updates the collection of IP addresses associated with network access point 104. The method 400 creates 408 an association response comprising a connection identifier and sends the response to the mobile device accepting the association request and the method 400 ends.

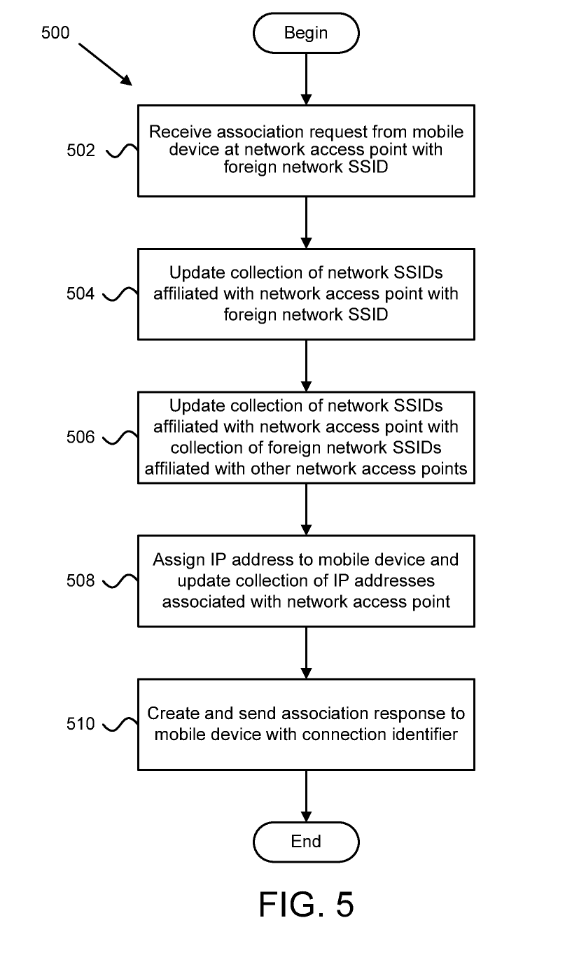

FIG. 5 is a schematic flow chart diagram illustrating another embodiment of a method for reducing signal interference in a highly dense wireless environment. The method 500 begins and receives 502, at a network access point 104 affiliated with a collection of network SSIDs, an association request from a mobile device 108 comprising an foreign network SSID of a network profile stored on the mobile device 108. In one embodiment, the method 500 updates 504 the collection of network SSIDs affiliated with the network access point 104 with the foreign network SSID by associating the foreign network SSID with an identifier of the network access point 104. The method 500 updates 506 the collection of network SSIDs affiliated the network access points 104 with a collection of foreign network SSIDs affiliated with one or more other network access points 104. The method 500 assigns 508 an IP address to the mobile device and updates the collection of IP addresses associated with network access point 104. The method 500 creates 510 an association response comprising a connection identifier and sends the response to the mobile device accepting the association request and the method 500 ends.

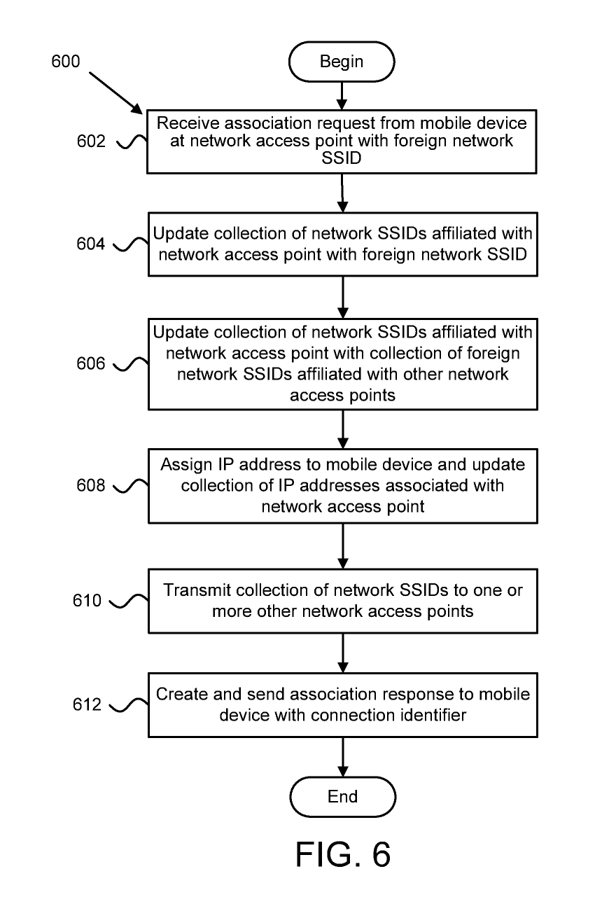

FIG. 6 is a schematic flow chart diagram illustrating yet another embodiment of a method for reducing signal interference in a highly dense wireless environment. The method 600 begins and receives 602, at a network access point 104 affiliated with a collection of network SSIDs, an association request from a mobile device 108 comprising an foreign network SSID of a network profile stored on the mobile device 108. In one embodiment, the method 600 updates 604 the collection of network SSIDs affiliated with the network access point 104 with the foreign network SSID by associating the foreign network SSID with an identifier of the network access point 104. The method 600 updates 606 the collection of network SSIDs affiliated the network access points 104 with a collection of foreign network SSIDs affiliated with one or more other network access points 104. The method 600 assigns 608 an IP address to the mobile device and updates the collection of IP addresses associated with network access point 104. The method 600 transmits 610 the collection of network SSIDs affiliated with the network access point 104 to one or more other network access points 104. The method 600 creates 612 an association response comprising a connection identifier and sends the response to the mobile device accepting the association request and the method 600 ends.

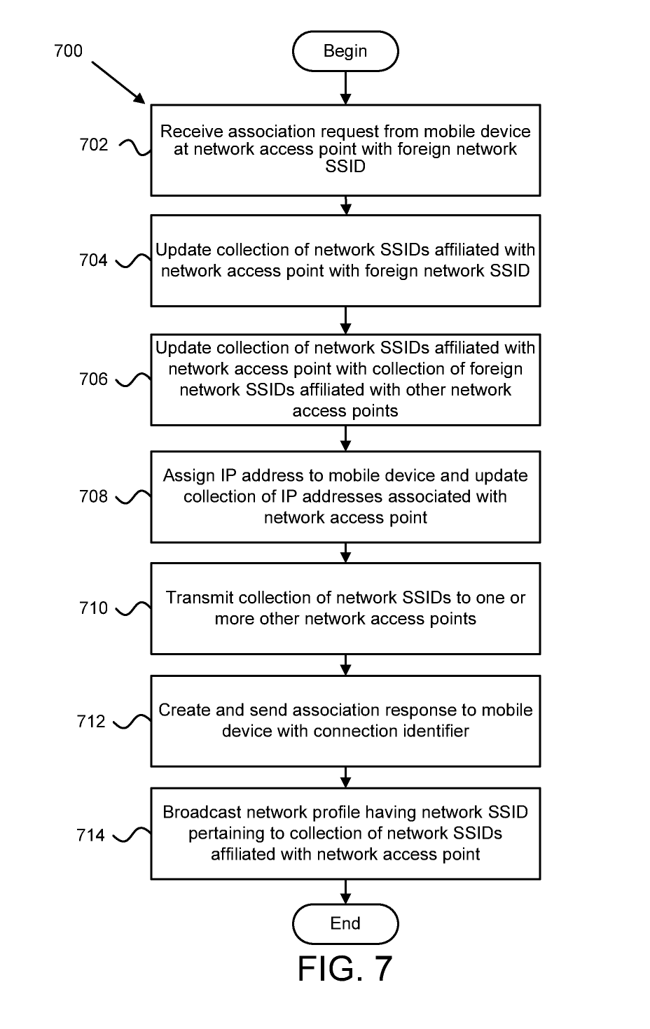

FIG. 7 is a schematic flow chart diagram illustrating still another embodiment of a method for reducing signal interference in a highly dense wireless environment. The method 700 begins and receives 702, at a network access point 104 affiliated with a collection of network SSIDs, an association request from a mobile device 108 comprising an foreign network SSID of a network profile stored on the mobile device 108. In one embodiment, the method 700 updates 704 the collection of network SSIDs affiliated with the network access point 104 with the foreign network SSID by associating the foreign network SSID with an identifier of the network access point 104. The method 700 updates 706 the collection of network SSIDs affiliated the network access points 104 with a collection of foreign network SSIDs affiliated with one or more other network access points 104. The method 700 assigns 708 an IP address to the mobile device and updates the collection of IP addresses associated with network access point 104. The method 700 transmits 710 the collection of network SSIDs affiliated with the network access point 104 to one or more other network access points 104. The method 700 creates 712 an association response comprising a connection identifier and sends the response to the mobile device accepting the association request. The method 700 broadcasts 714 a network profile having a network SSID pertaining to the collection of network SSIDs affiliated with the network access point 104 and the method 700 ends.

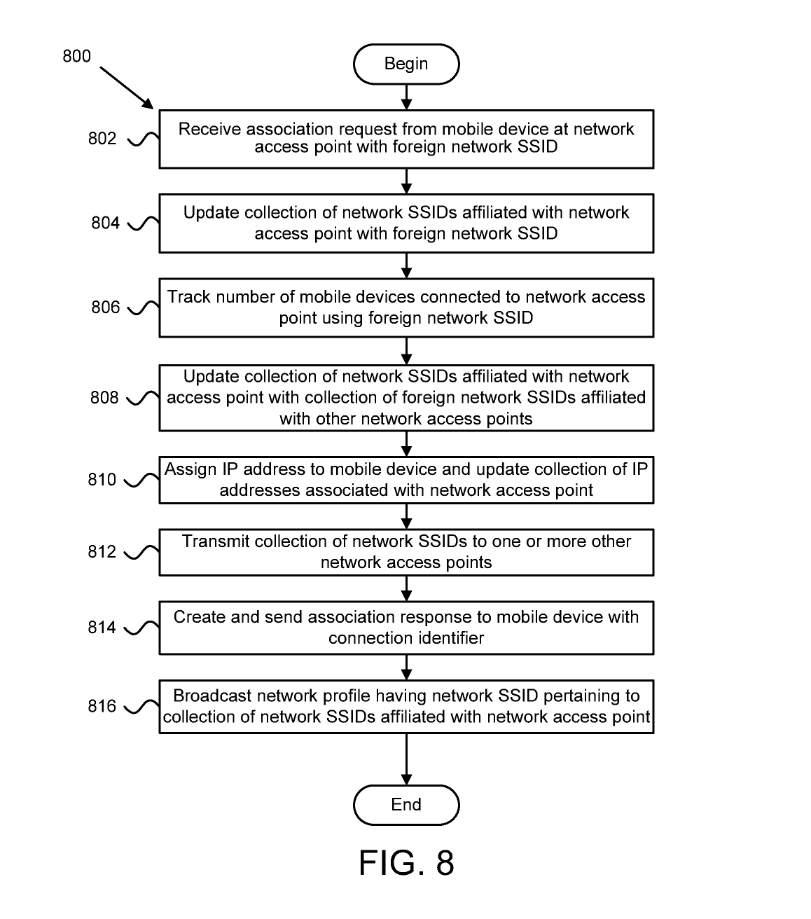

FIG. 8 is a schematic flow chart diagram illustrating still another embodiment of a method for reducing signal interference in a highly dense wireless environment. The method 800 begins and receives 802, at a network access point 104 affiliated with a collection of network SSIDs, an association request from a mobile device 108 comprising an foreign network SSID of a network profile stored on the mobile device 108. In one embodiment, the method 800 updates 804 the collection of network SSIDs affiliated with the network access point 104 with the foreign network SSID by associating the foreign network SSID with an identifier of the network access point 104. The method 800 tracks 806 a number of mobile devices 108 connected to the network access point 104 using a foreign network SSID. In one embodiment, the method 800 tracks 806 a number of mobile devices 108 connected to the network access point 104 using a network SSID affiliated with the network access point 104. The method 800 updates 808 the collection of network SSIDs affiliated the network access points 104 with a collection of foreign network SSIDs affiliated with one or more other network access points 104. The method 800 assigns 810 an IP address to the mobile device and updates the collection of IP addresses associated with network access point 104. The method 800 transmits 812 the collection of network SSIDs affiliated with the network access point 104 to one or more other network access points 104. The method 800 creates 814 an association response comprising a connection identifier and sends the response to the mobile device accepting the association request. The method 800 broadcasts 816 a network profile having a network SSID pertaining to the collection of network SSIDs affiliated with the network access point 104 and the method 800 ends.

The embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus comprising:
a listener module that receives, at a network access point affiliated with a collection of one or more network SSIDs, an association request from a mobile device, the association request having a foreign network SSID;
a response module that sends an association response to the mobile device accepting the association request in response to receiving the association request, the response having a connection identifier;
a tracking module that updates the collection of one or more network SSIDs affiliated with the network access point with the foreign network SSID; and
wherein at least a portion of the listener module, the response module, and the tracking module comprise one or more of hardware and executable code, the executable code stored on one or more computer readable storage media.

2. The apparatus of claim 1, wherein the tracking module updates the collection of one or more network SSIDs affiliated with the network access point with the foreign network SSID comprises associating the foreign network SSID with an identifier of the network access point.

3. The apparatus of claim 1, wherein the tracking module further updates the collection of one or more network SSIDs affiliated with the network access point with a collection of one or more foreign network SSIDs affiliated with one or more other network access points.

4. The apparatus of claim 1, wherein the tracking module further tracks a number of mobile devices connected to the network access point using a network SSID affiliated with the network access point.

5. The apparatus of claim 1, further comprising a notification module that transmits the collection of one or more network SSIDs affiliated with the network access point to one or more other network access points.

6. The apparatus of claim 5, wherein the notification module further broadcasts a network profile to the mobile device, the network profile having a network SSID pertaining to the collection of one or more network SSIDs affiliated with the network access point.

7. The apparatus of claim 6, wherein the network profile has a network SSID used by a mobile device connected to the network access point.

8. A method comprising:
receiving, at a network access point affiliated with a collection of one or more network SSIDs, an association request from a mobile device, the association request having a foreign network SSID;
sending an association response to the mobile device accepting the association request in response to receiving the association request, the response having a connection identifier;
updating the collection of one or more network SSIDs affiliated with the network access point with the foreign network SSID.

9. The method of claim 8, wherein updating the collection of one or more network SSIDs affiliated with the network access point with the foreign network SSID comprises associating the foreign network SSID with an identifier of the network access point.

10. The method of claim 8, further comprising updating the collection of one or more network SSIDs affiliated with the network access point with a collection of one or more foreign network SSIDs affiliated with one or more other network access points.

11. The method of claim 8, further comprising transmitting the collection of one or more network SSIDs affiliated with the network access point to one or more other network access points.

12. The method of claim 8, further comprising broadcasting a network profile to the mobile device, the network profile having a network SSID from the collection of one or more network SSIDs affiliated with the network access point.

13. The method of claim 8, further comprising broadcasting a network profile to the mobile device, the network profile having a network SSID pertaining to the collection of one or more network SSIDs affiliated with the network access point.

14. The method of claim 13, wherein the network profile has a network SSID used by a mobile device connected to the network access point.

15. A computer program product comprising a non-transitory computer readable storage medium storing computer usable program code executable to perform operations comprising:
receiving, at a network access point affiliated with a collection of one or more network SSIDs, an association request from a mobile device, the association request having a foreign network SSID;
sending an association response to the mobile device accepting the association request in response to receiving the association request, the response having a connection identifier;
updating the collection of one or more network SSIDs affiliated with the network access point with the foreign network SSID.

16. The computer program product of claim 15, wherein updating the collection of one or more network SSIDs affiliated with the network access point with the foreign network SSID comprises associating the foreign network SSID with an identifier of the network access point.

17. The computer program product of claim 15, further comprising updating the collection of one or more network SSIDs affiliated with the network access point with a collection of one or more foreign network SSIDs affiliated with one or more other network access points.

18. The computer program product of claim 15, further comprising transmitting the collection of one or more network SSIDs affiliated with the network access point to one or more other network access points.

19. The computer program product of claim 15, further comprising broadcasting a network profile to the mobile device, the network profile having a network SSID from the collection of one or more network SSIDs affiliated with the network access point.

20. The computer program product of claim 19, further comprising broadcasting a network profile to the mobile device, the network profile having a network SSID pertaining to the collection of one or more network SSIDs affiliated with the network access point.
